(19) United States
(12) Patent Application Publication
(10) Pub. No.: US 2015/0312652 A1
(43) Pub. Date: Oct. 29, 2015

(54) AUTOMATIC GENERATION OF VIDEOS VIA A SEGMENT LIST

(71) Applicant: Microsoft Corporation, Redmond, WA (US)

(72) Inventors: Simon Baker, Los Altos Hills, CA (US); Eran Borenstein, Los Gatos, CA (US); Eitan Sharon, Palo Alto, CA (US); Mehmet Nejat Tek, Santa Clara, CA (US)

(73) Assignee: Microsoft Corporation, Redmond, WA (US)

(21) Appl. No.: 14/260,565

(22) Filed: Apr. 24, 2014

(51) Int. Cl. H04N 21/8549; H04N 21/44; G11B 27/036

(52) U.S. Cl. CPC H04N 21/8549; G11B 27/036; H04N 21/44008

(57) ABSTRACT

A system and method are disclosed for automatically generating a highlight reel of video content. Segments from a segment list may be associated with, or indexed to, corresponding sequences from a video of an event for which the segment list is prepared. Thereafter, also using the segment list, segments may be scored using a variety of predefined criteria to come up with segments which are likely to be of greatest interest to a particular user. The video sequences associated with the highest scored segments are used as the video highlight reel.

### BACKGROUND

Instead of watching an entire event such as a sporting event, users often prefer to watch a summary, or highlight reel, of the event. It is known to have highlight shows that compile highlights from sporting and other events. These highlight shows are manually produced and choreographed by a television production team to have high production value. Users who record or download a video at present do not have an easy way to browse the video for highlights. It would be desirable to have a system for automatically producing a highlight reel from a recorded or downloaded video which had the look and feel of a high quality, manually produced television production.

### SUMMARY

The present technology, roughly described, relates in general to a system for automatically generating a highlight reel of video content. In embodiments, this highlight reel may be augmented with features providing the highlight reel with a high quality production appearance. In embodiments, the present system works in tandem with a segment list which includes a list of different segments of an event. One typical example of a segment list is a play-by-play (PBP) which is prepared contemporaneously with a sporting event and describes features and what went on during respective segments of the sporting event.

In accordance with the present technology, segments from a segment list may be associated with, or indexed to, corresponding sequences from a video of an event for which the segment list is prepared. Thereafter, also using the segment list, segments may be scored using a variety of predefined criteria to come up with segments which are likely to be of greatest interest to a particular user. The video sequences associated with the highest scored segments are used as the video highlight reel.

In one example, the present technology relates to a method of generating a video highlight reel, comprising: (a) indexing a video to a segment list setting forth the video sequences in the video to identify positions of different video sequences within the video; (b) comparing data from segments in the segment list against one or more predefined rules to identify one or more segments that satisfy a rule of the one or more predefined rules; and (c) selecting one or more video sequences into the highlight reel, the one or more selected video sequences having corresponding segments from the segment list that satisfied the rule of the one or more predefined rules in said step (b).

In another example, the present technology relates to a computer readable medium for programing a processor to perform a method of generating an interactive video highlight reel, comprising: (a) correlating segments in a segment list to video sequences in a video; (b) identifying one or more video sequences for inclusion in the video highlight reel, a video sequence included in the video highlight reel where a segment, correlated to the video sequence, satisfies one or more predefined rules; (c) displaying an interactive script including a plurality of script segments, a script segment of the plurality of script segments matched to a video sequence identified for inclusion in the video highlight reel in said step (b); (d) receiving selection of the script segment displayed in said step (c); and (e) displaying the video sequence matched to the script segment upon selection of the script segment in said step (d).

In a further example, the present technology relates to a system for generating a video highlight reel, comprising: a video including a plurality of videos sequences from one or more events, a group of one or more video sequences selected for inclusion in a highlight reel; one or more segment lists including a listing of segments corresponding to the video sequences from the one or more events; and an interactive script including script segments, displayed on a display of a computing device, the interactive script generated based on the segments of the segment list corresponding to the video sequences selected into the highlight reel, selection of a script segment from the interactive script displaying a corresponding highlight reel video sequence.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a schematic block diagram of a computing system for implementing aspects of the present technology.

FIG. 2 is a schematic block diagram of a computing system for implementing further aspects of the present technology.

FIG. 3 depicts a system implementing aspects of the present technology.

FIG. 4 depicts an alternative system implementing aspects of the present technology.

FIG. 5 is a schematic block diagram illustrating aspects of the present technology.

FIG. 6 is a flowchart for indexing a segment list to a video according to embodiments of the present technology.

FIG. 7 is a flowchart providing more detail by step 222 from FIG. 6.

FIG. 8 is a flowchart including further steps for indexing a segment list to a video according to embodiments of the present technology.

FIGS. 9A and 9B are flowcharts for automatically selecting videos into a highlight reel according to different embodiments of the present technology.

FIG. 10 is a flowchart for processing a highlight reel including videos, voice over and contextual introductions, transitions and closing video clips.

FIG. 11 is a flowchart for browsing an indexed video according to embodiments of the present technology.

FIGS. 12-15 are examples of interactive scripts for a highlight reel displayed on a user interface of a computing device according to embodiments of the present technology.

FIG. 16 is a block diagram of an exemplary processing device.

FIG. 17 is a block diagram of an exemplary console device.

### DETAILED DESCRIPTION

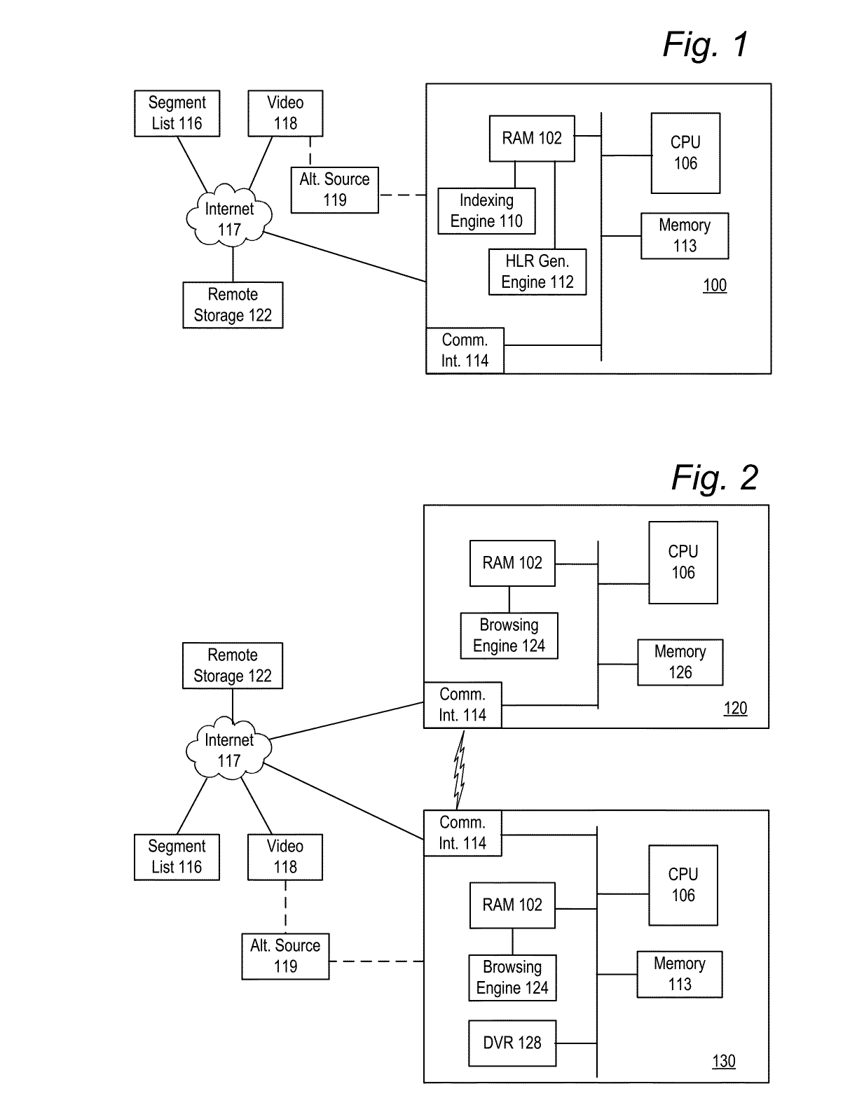

The present technology will now be described with reference to FIGS. 1-17, which in general relate to a system and method for automatically generating a highlight reel including web content, and quickly and easily browsing to points of interest within the highlight reel. In embodiments, the present system works in tandem with a segment list which includes a list of different segments of an event. One typical example of a segment list is a play-by-play (PBP) which is prepared contemporaneously with a sporting event and describes features and what went on during respective segments of the sporting event. For example, a PBP from a football game may have a listing of each play, including a game clock time of the play, a yard line where the play began, a description of the play and a result. Embodiments of the present technology may work with PBPs for other sporting events, and segment lists for events which are unrelated to sports. Segment lists may be generated by third parties for use in conjunction with the present technology.

In accordance with one aspect of the present technology, segments from a segment list may be associated with, or indexed to, corresponding points or segments in a video of an event for which the segment list is prepared. A length of the video sequence associated with each segment may also be defined. In the example of a football game, a single segment from the segment list and a sequence from the video may be a single play (kickoff, running play, passing play, punt, etc). The present technology indexes segments from the segment list to their corresponding sequences in the video where those segments occur and are displayed.

Either during or after the indexing of a video, the segment list may be analyzed for interesting or noteworthy segments for inclusion in a highlight reel. These may be segments which are determined to be of general interest, or of specific interest to a user for whom the highlight reel is created. The video sequences associated with the noteworthy segments may be processed into the highlight reel together with voice overlay and contextual content. The highlight reel may then be rendered and interactively browsed as explained below.

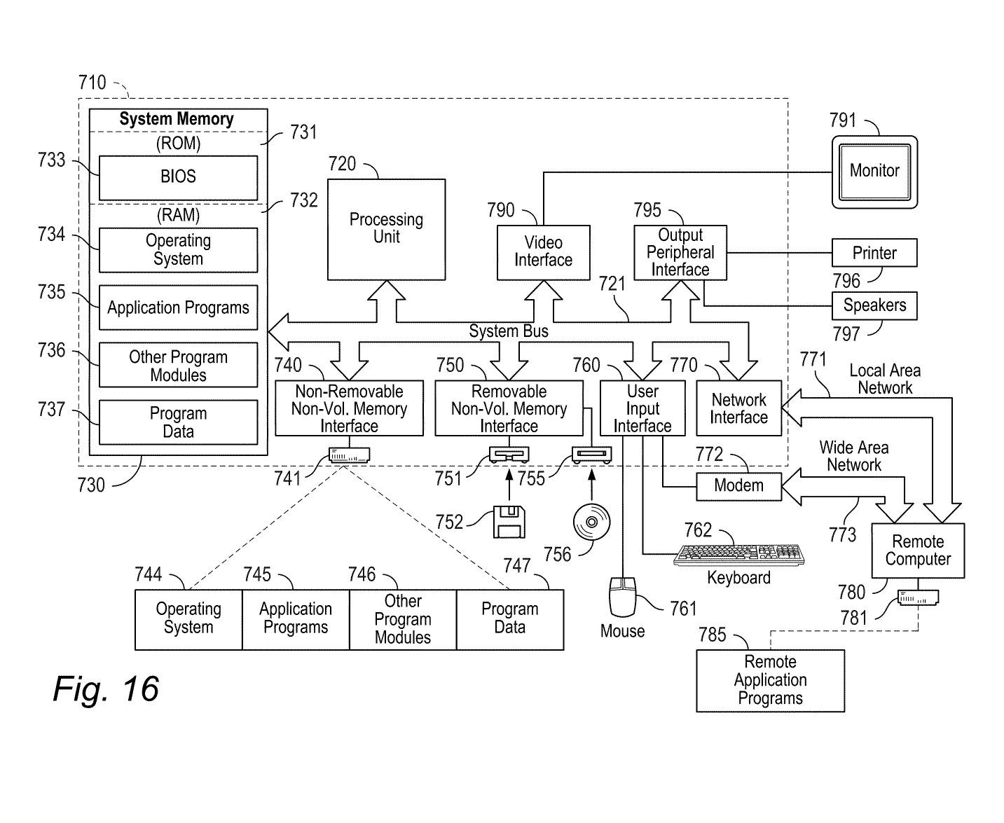

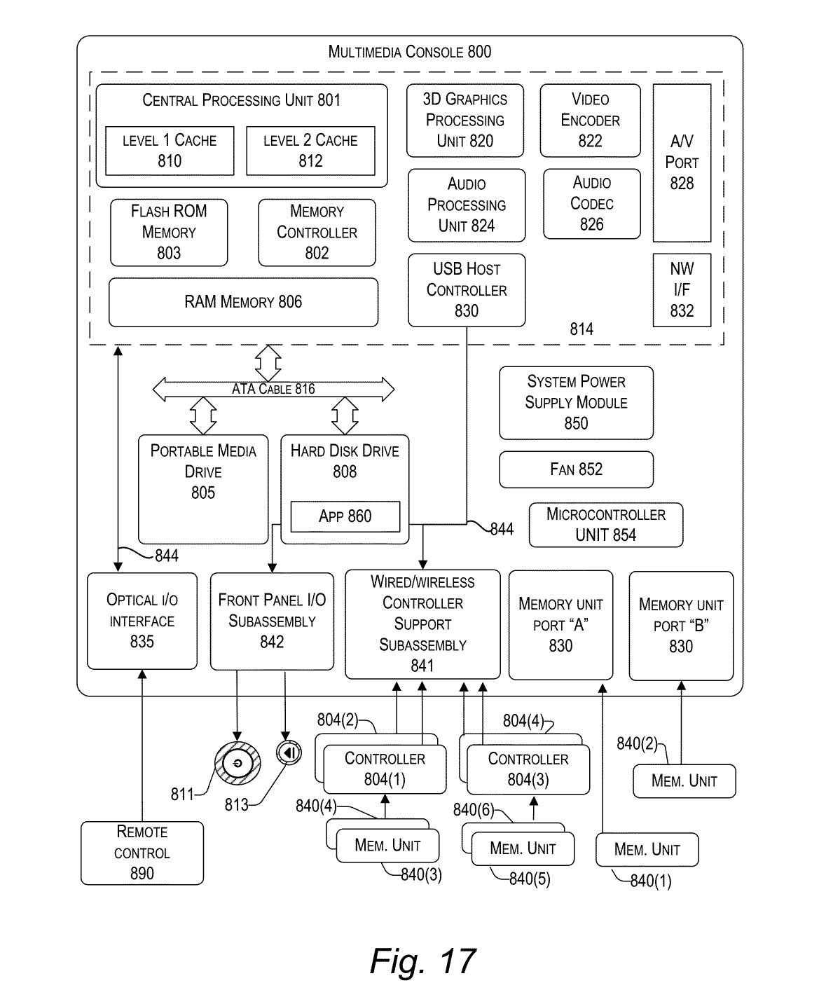

Referring to FIG. 1, there is shown a schematic drawing of a computing device 100. A more detailed description of a computing system of which computing device 100 may be an example is provided below with reference to FIGS. 16 and 17. However, in general, computing device 100 may include random access memory (RAM) 102 and a central processing unit (CPU) 106. The CPU 106 may execute a first software engine, referred to herein as an indexing engine 110, for indexing a segment list to a video, and a second software engine, referred to herein as a highlight reel (HLR) generation engine 112, for generating a highlight reel including video sequences from the indexed video. In embodiments, these software engines receive a video 118 of an event and a segment list 116 including segmented descriptions of different sequences from the event. The video 118 could be in various formats, such as for example an .mp4 file, though other formats are possible.

The segment list 116 and video 118 may be received and stored in the computing device 100 from remote sources via a network connection such as the Internet 117. The video may alternatively or additionally arrive via an alternate source 119 in further embodiments, such as for example via cable TV, satellite TV, terrestrial broadcast etc. The received segment list 116 may include a segment-by-segment description of different sequences from the video, where one segment from the segment list corresponds to one sequence from the stored video.

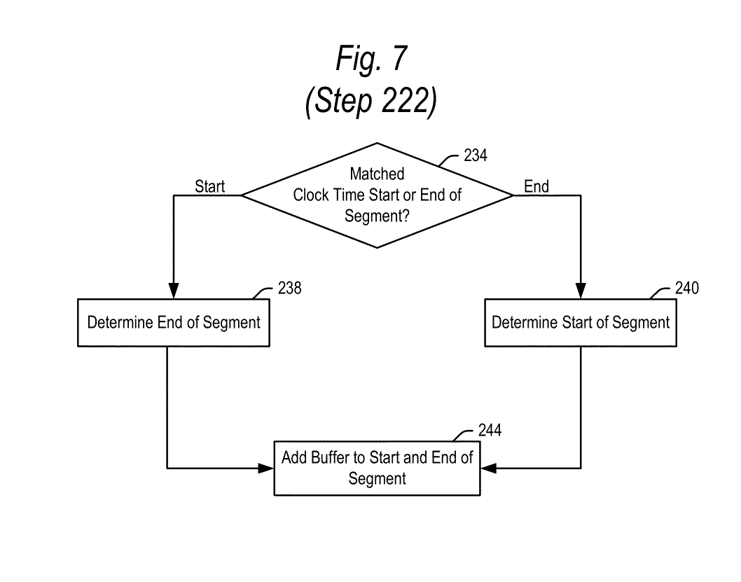

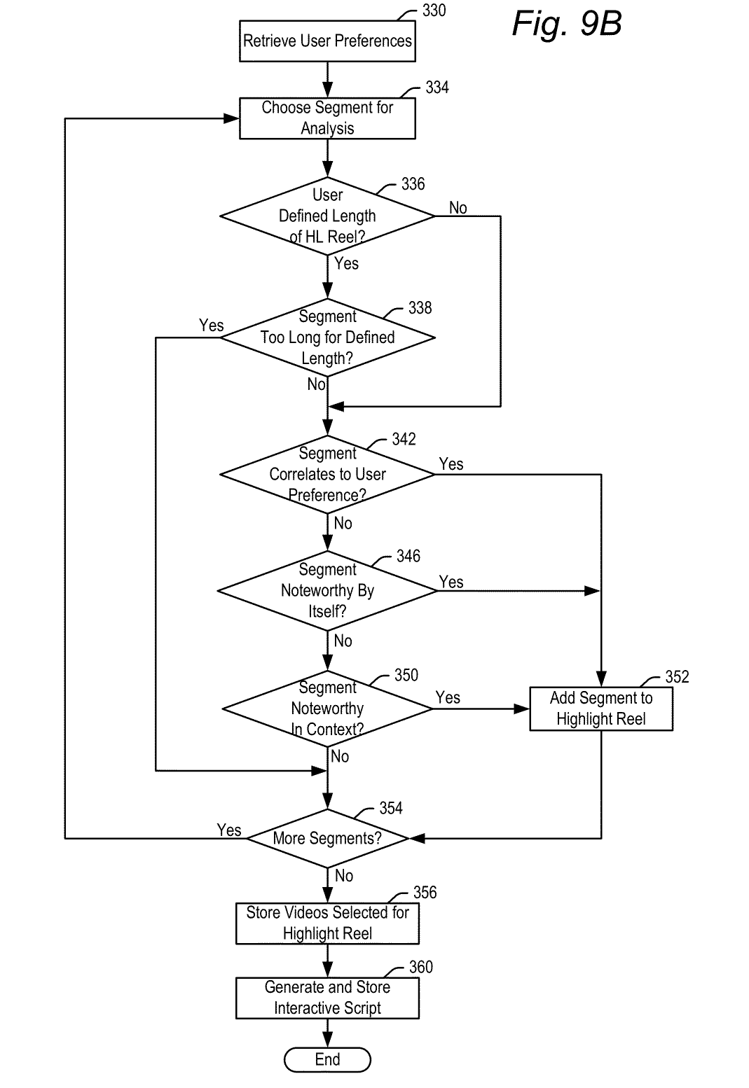

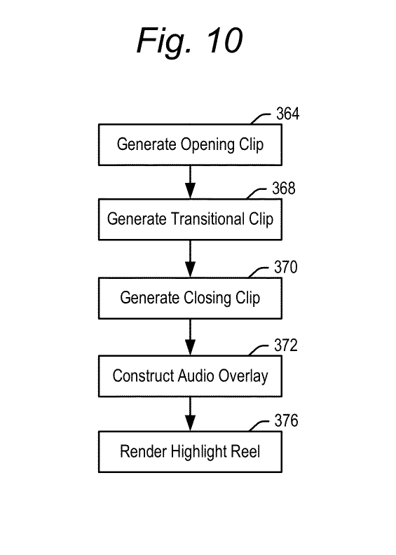

The result of the operation of the indexing engine 110 may be a table correlating sequences from the video 118 of determined lengths to their respective corresponding segments from the segment list 116. This table may be stored in a memory 113, which may resident within computing device 100. Alternatively or additionally, the indexing table may be stored remotely from computing device 100, for example on remote storage 122. Details relating to the operation of the indexing engine 110 to generate the indexing table are explained below with reference to the flowchart of FIG. 6. Details relating to the operation of the HLR generation engine 112 to generate an interactive highlight reel are explained below with reference to the flowcharts of FIGS. 9 and 10.

In embodiments, a segment list is indexed to a single, stored video of an event. However, it is conceivable that a segment list may be indexed to multiple stored videos of the same event. In particular, it may happen that more than one video feed is captured of a given event. For example, more than one network or content provider may capture video of the same event such as a football game. Alternatively or additionally, the same network may capture the event using multiple cameras. Each video feed in these examples will capture the same sequences of the event, but the actual video from the different feeds may differ from each other (different perspectives, focus, etc.). It is conceivable that both videos be stored, and that sequences from both videos be indexed to a single segment list as explained below. When a user browses to sequences from the stored highlight reel of the video event as also explained below, the user may be shown sequences from both stored videos, or be given the option to choose one video sequence or another from the different stored videos of the event.

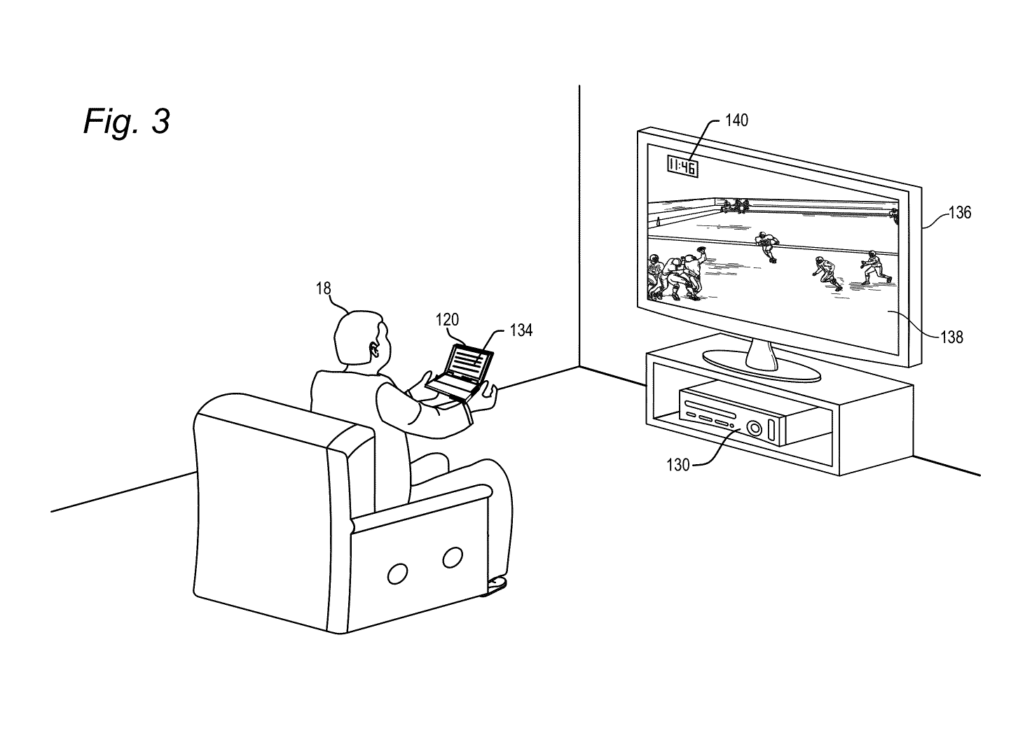

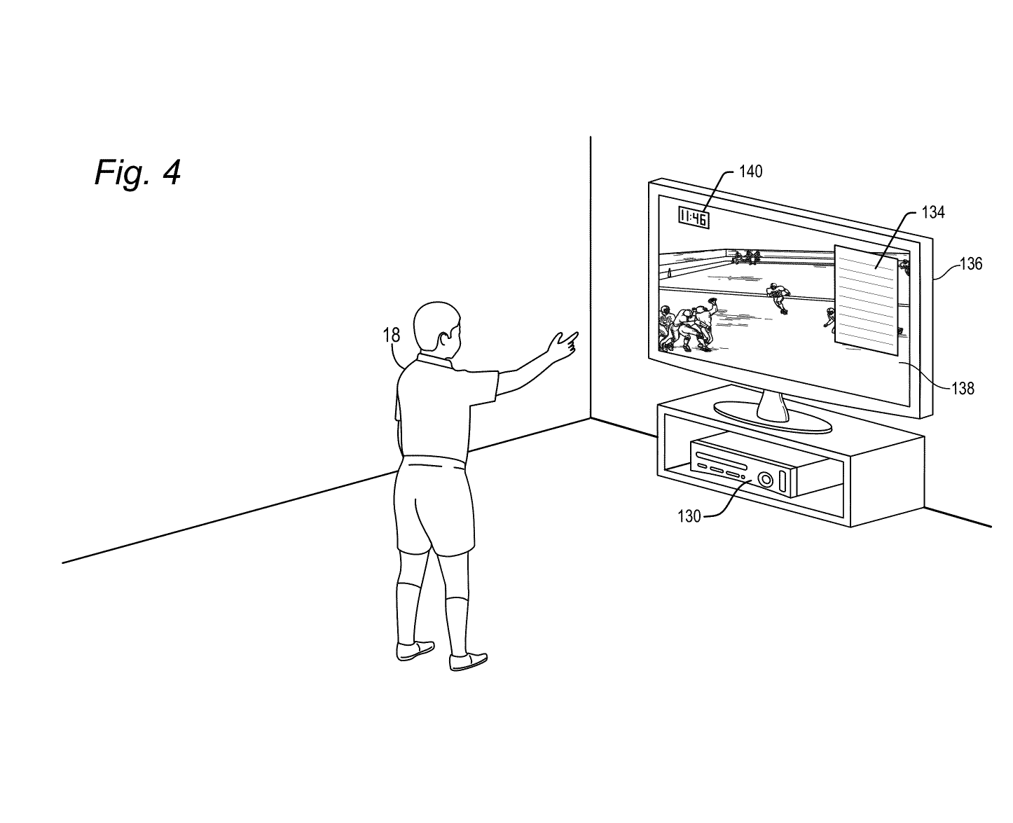

In accordance with a further aspect of the present technology, after the stored video is indexed and a highlight reel has been created, users may interactively watch, or browse, the highlight reel video by jumping to desired sequences in the video for playback. FIG. 2 shows a schematic drawing of computing devices 120 and 130, one or both of which may execute a software engine referred to herein as a browsing engine 124 for interactive browsing of a stored video. FIG. 2 shows certain other features of computing devices 120, 130, but a more detailed description of a computing system of which computing devices 120, 130 may be examples is provided below with reference to FIGS. 16 and 17. FIG. 3 illustrates a use scenario for the computing devices 120 and 130. As explained below, the browsing experience provided by browsing engine 124 may be implemented on a single computing device in further embodiments.

The computing device 120 may for example be a hand-held computing device such as a mobile phone, laptop or tablet displaying a user interface 104. It may be a computing device other than a hand-held device in further embodiments, such as a desktop computer. The computing device 130 may be a desktop computer, media center PC, a set-top box and the like. It may be a portable computer similar to computing device 120 in further embodiments.

The computing device 130 may be connected to an audio/visual (A/V) device 136 having a display 138 (FIG. 3). The device 136 may for example be a television, a monitor, a high-definition television (HDTV), or the like that may provide a video feed, game or application visuals and/or audio to a user 18. For example, the computing device 130 may include a video adapter such as a graphics card and/or an audio adapter such as a sound card that may provide audio/visual signals associated with a recorded or downloaded video feed. In one embodiment, the audio/visual device 136 may be connected to the computing device 130 via, for example, an S-Video cable, a coaxial cable, an HDMI cable, a DVI cable, a VGA cable, a component video cable, or the like.

In embodiments, the computing device 130 may further include a device such as a digital video recorder (DVR) 128 for recording, storing and playing back video content, such as sports and other events. The video content may be received from an external computer-readable medium such as a DVD, or it may be downloaded to the DVR 128 via a network connection such as the Internet 117. In further embodiments, the DVR 128 may be a standalone unit. Such a standalone unit may be connected in line with the computing device 130 and the A/V device 136.

It is conceivable that the present technology not operate with a DVR within or directly connected to the computing device 130. In such an embodiment, video content may be stored on a remote content server, such as for example remote storage 122, and downloaded via the Internet 117 to the computing device 130 based on selections made by the user as explained below.

In embodiments including two computing devices such as computing devices 120 and 130, the system may be practiced in a distributed computing environment. In such embodiments, devices 120 and 130 may be linked through a communications network implemented for example by communications interfaces 114 in the computing devices 120 and 130. One such distributed computing environment may be accomplished using the Smartglass™ software application from Microsoft Corporation which allows a first computing device to act as a display and/or other peripheral to a second computing device. Thus, the computing device 120 may provide a user interface for browsing video content stored on the computing device 130 for display on the A/V device 136. In such a distributed computing environment, a browsing engine 124 for implementing video browsing aspects of the present technology may be located on one or both computing devices 120 and 130 (in the embodiment shown in FIGS. 2 and 3, it is resident on both devices 120 and 130).

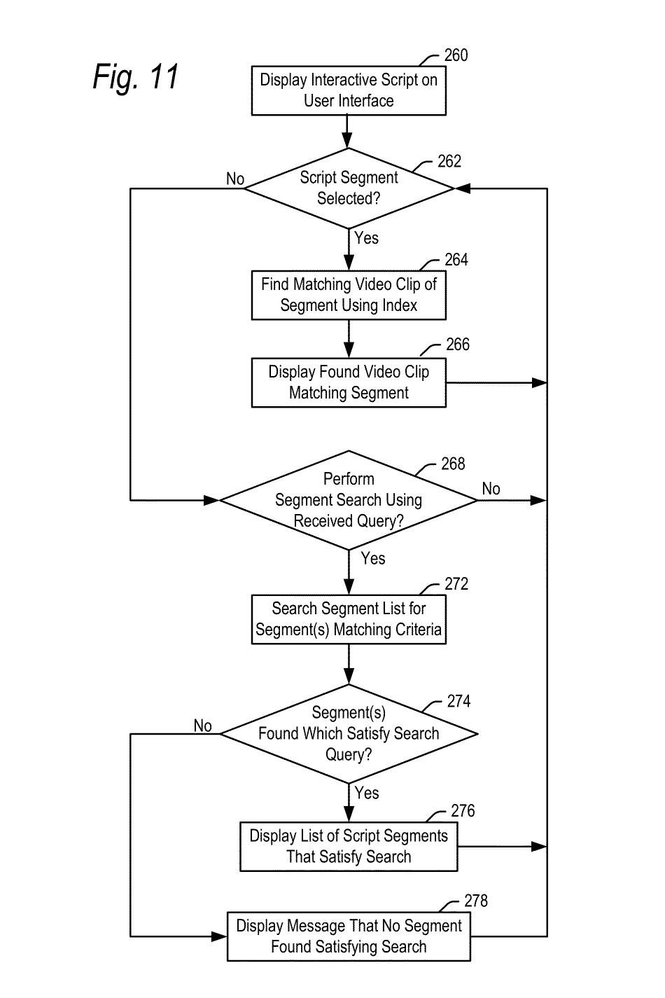

Browsing engine 124 generates a user interface 134 (FIG. 3) presenting an interactive script for a recorded highlight reel video that may be stored on DVR 128. When a user selects a particular segment (or group of segments) from the interactive script on the user interface 134, the browsing engine 124 may access the indexing table stored in local memory 113 or remote storage 122 so that the corresponding video sequence or sequences from the highlight reel may then be displayed to the user. Details relating to the browsing engine 124 for making video selections and browsing a video are described below with reference to the flowchart of FIG. 11.

In embodiments, the computing device 100 and the computing device 130 may be the same or different computing devices. In embodiments where the devices 100 and 130 are the same, an indexed video may be recorded and saved on DVR 128, and then played back from DVR 128. Additionally, the indexing table generated by the indexing engine 110 may be stored on local memory 113, and accessed from local memory 113 when browsing a video.

It is understood that the functions of computing devices 100, 120 and/or 130 may be performed by numerous other general purpose or special purpose computing system environments or configurations. Examples of other well-known computing systems, environments, and/or configurations that may be suitable for use with the system include, but are not limited to, multiprocessor systems, microprocessor-based systems, set top boxes, programmable consumer electronics, network PCs, minicomputers, distributed computing environments that include any of the above systems or devices, and the like.

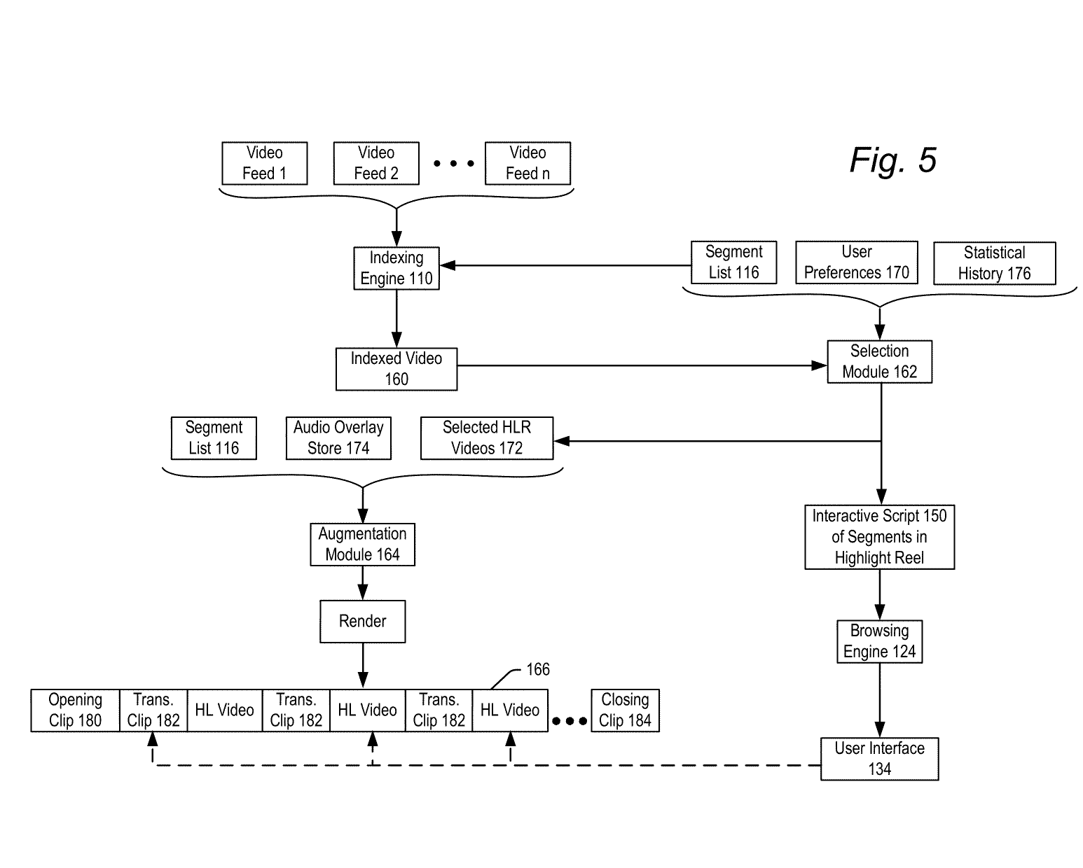

In the embodiments described above, browsing of videos may be accomplished using multiple (two or more) computing devices in a distributed computing environment. In further embodiments, a single computing device may be used to implement the browsing aspects of the present technology. In such an embodiment, shown in FIG. 4, a single computing device (for example computing device 130) may display both a video and an interactive script on a user interface 134. A user may bring up and interact with the user interface 134 via a natural user interface (NUI) to provide gestural or verbal input to the user interface 134 to select video sequences to watch on the display 138. The user interface 134 may disappear when not in use for a period of time. In the embodiment of FIG. 4, a remote control or other selection device may be used instead of a NUI system to interact with the user interface 134.

The description of the present technology below often uses an example where the event is a sporting event having a running clock associated with each sequence from a video (such as running clock 140 shown on FIGS. 3 and 4). Such sporting events include for example football games, basketball games, soccer games, hockey games, timed track and field events and timed skiing and winter sports events. In the example of a football game, a sequence is a single play that begins and ends at a set time on the game clock. However, the present technology may also be used to browse sporting events that do not have a running clock associated with sequences of a video. Such sporting events include for example baseball games, tennis matches, golf tournaments, non-timed track and field events, non-timed skiing and winter sport events and gymnastics. The present technology may also be used to browse non-sporting events where a video of the event may be divided into different sequences. For example, talk shows, news broadcasts, movies, concerts and other entertainment and current events may often be broken down into different scenes, skits, etc. Each of these is explained in greater detail below.

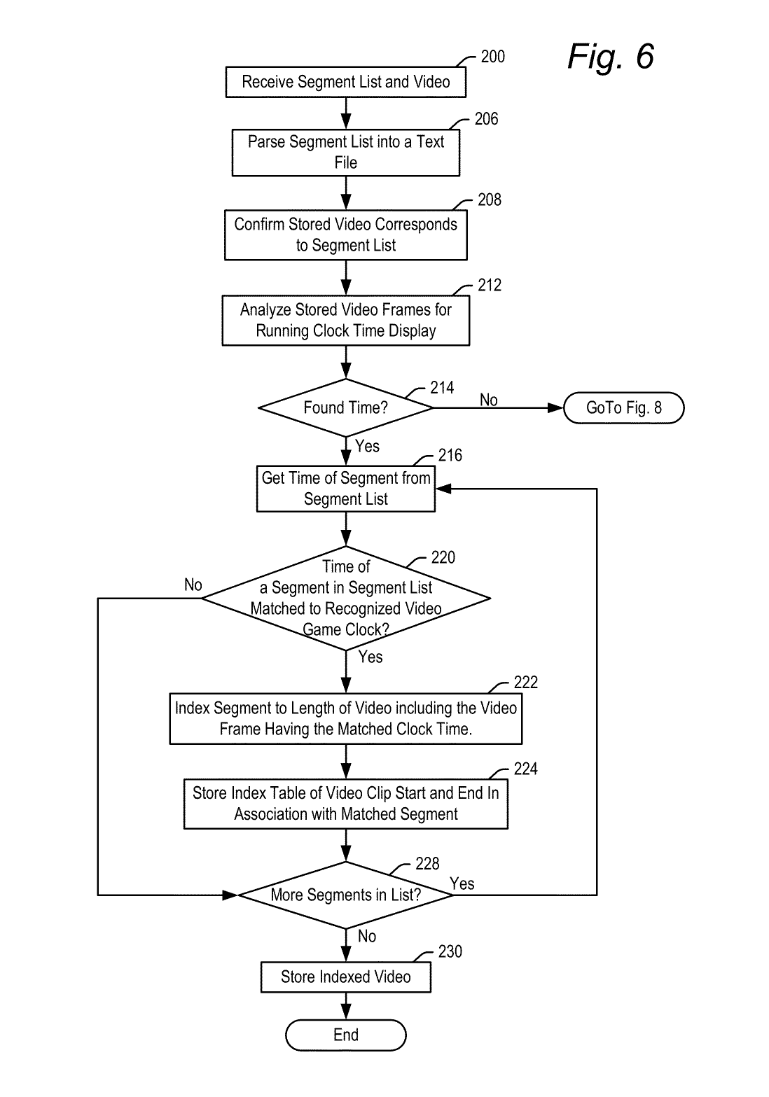

A high-level description of aspects of the present technology will now be explained with reference to the schematic block diagram of FIG. 5. One or more video feeds (video feed 1, video feed 2, . . . , Video feed n) are indexed by the indexing engine 110 using a segment list 116 to produce an indexed video 160. Using the segment list as explained below, the indexing engine 110 identifies the position of video sequences within the video. Operation of the indexing engine 110 according to embodiments of the present technology will now be explained with reference to the flowchart of FIG. 6. The indexing engine 110 may be implemented to index a PBP or other segment list to sequences from a stored video, and to define the length of video sequences associated with the segments in the segment list. In step 200, the indexing engine 110 receives a segment list 116 and video 118. The segment list may be prepared by a third-party service specifically for the video 118, and received via a network such as the Internet 117. The video may for example be broadcast via cable or satellite television, or downloaded via the internet 117.

In embodiments, the segment list 116 prepared by the third-party service may be a structured data feed including known fields of data categories. For example, where the segment list 116 is a structured feed from a football game, a first data field may describe the down (i.e., first, second, third or fourth) and the yards needed for a first down; a second data field may provide the game clock time at which the play started or ended; and a third data field may describe the play and result. These fields are a way of example only, and the segment list may include alternative and/or additional data fields. Structured data fields may be easily searched for information (such as a running game clock) that may be used to index segments from the segment list to stored video sequences of the event. In further embodiments, the segment list 116 prepared by the third-party service may alternatively be parsed into a text file in step 206 so that it may be searched for information that may be used to index segments to the stored video.

In step 208, the indexing engine 110 may confirm that the received segment list 116 corresponds to the received video 118. The video 118 may have certain descriptors or other metadata which may also be included as part of segment list 116 confirm that they correspond to each other. As used herein, metadata is a type of data.

In step 212, the indexing engine 110 may analyze frames of the stored video for display of a game clock having the running time for the event. For example, in a football game, the running game clock is generally displayed for each down that is played. An example of such a game clock 140 is shown FIGS. 3 and 4. A software routine, for example employing known optical character recognition techniques, may be used to analyze a video frame to identify a game clock, which will generally be in a known format. For example, the game clock in a football game will have one or two numeric digits, a colon, and then two more numeric digits.

In the description above and that follows, the example of a game clock is used to match a segment in the segment list to a sequence from the stored video. However, it is understood that, more generally, identifiers other than a game clock may appear in both the segments of the segment list and sequences from the video, and these other identifiers may be used to index segments to sequences of the video. It may be some other form of sequential alphanumeric text (ascendingly sequential or decendingly sequential) may be displayed in different sequences of the stored video and this alphanumeric text may also appear in respective segments of the segment list to mark the start or end of a sequence of the video that is described by the segment of the segment list. In this instance, the sequential alphanumeric text may be used to index the segments of the segment list to sequences of the video as described above and hereafter.

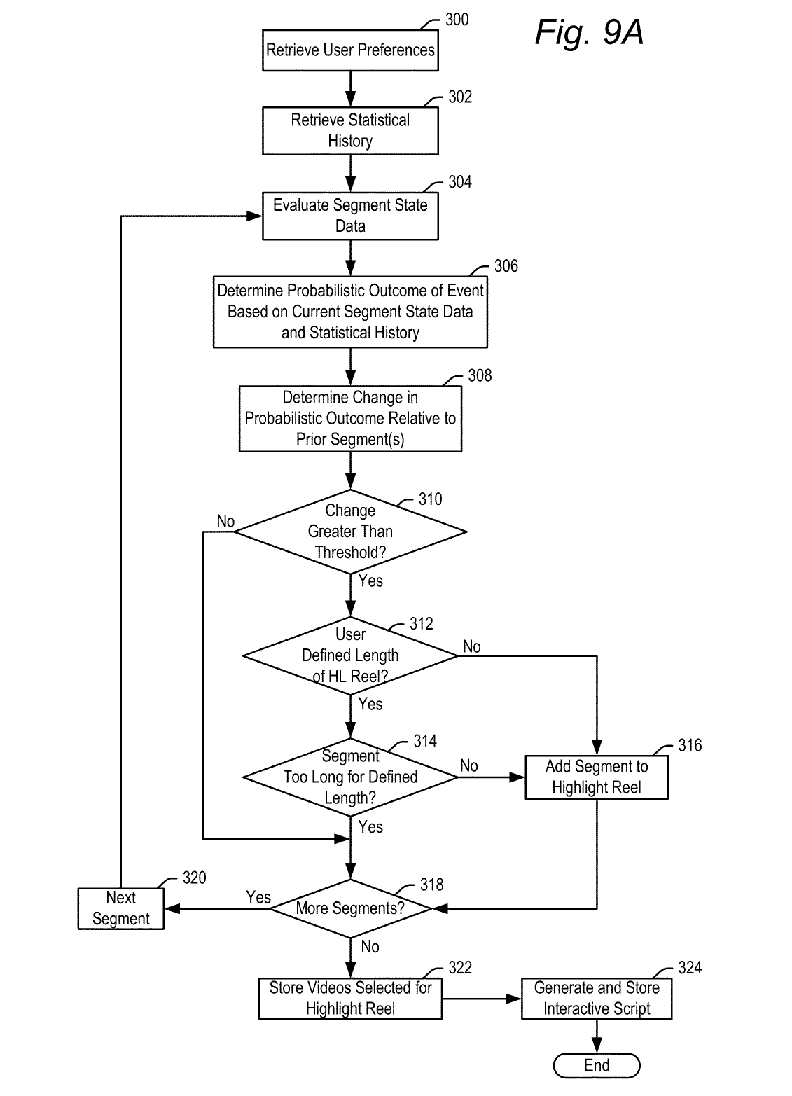

The indexing engine checks whether sequential alphanumeric text, such as a running game clock, was found in step 214. If not, the present technology employs various methods for identifying video frames at the start or end of a segment, as explained hereinafter with respect to the flowchart of FIG. 8.

However, if a game clock was identified in step 214, the indexing engine may take a game clock time of a segment from the segment list in step 216 and then determine whether a video frame is found having a game clock that matches the segment list time in step 220. For example, the indexing engine 110 may start with the first segment listed in the segment list. In a football game, this may be the opening kickoff starting with the game clock showing “15:00”. The indexing engine 110 searches for a video frame including a clock time 140 of “15:00”. If none is found, the indexing engine 110 may skip to step 228 to see if there more segments in the list. On the other hand, if a matching video frame is found, the indexing engine 110 may next perform step 222 of determining a length of video to index to the matched segment from the segment list as explained below.

In step 220, the indexing engine 110 may start with the first segment in the segment list 116 and proceed in succession through all segments in the segment list. However, the indexing engine 110 need not start with the first segment in further embodiments. Moreover, it is understood that several frames may have the same game clock time. For example, if the video has a frame rate of 30 frames per second, 30 frames should (ideally) have the same game clock time. In embodiments, the indexing engine 110 may take the first frame having a game clock time found to match the time of a segment from the segment list in step 220. Other frames having the matched time may be selected in further embodiments.

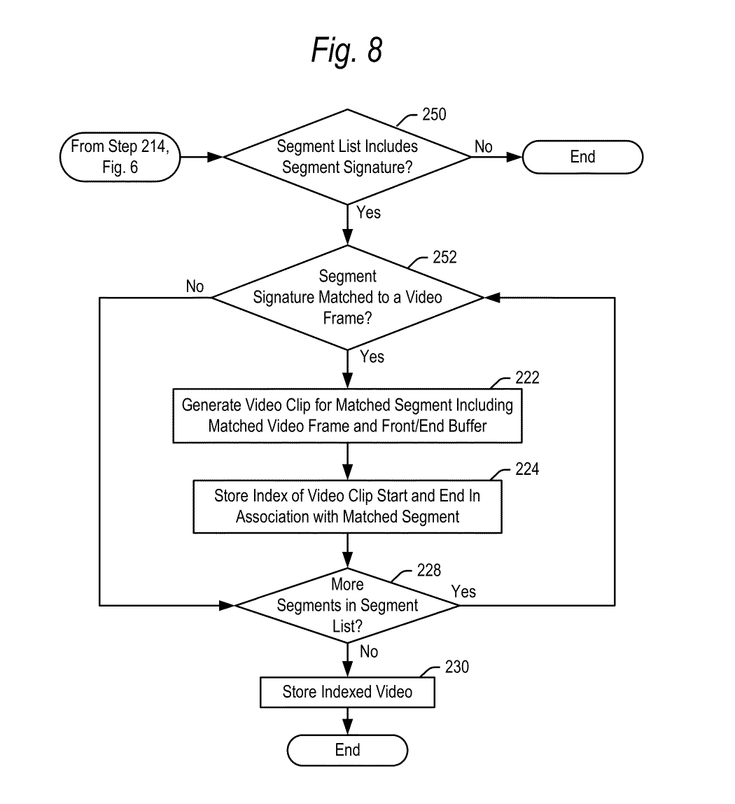

In step 222, the indexing engine 110 may index the segment from the segment list to a sequence of video including the video frame having the matched clock time. Further details of step 222 are now described with reference to the flowchart of FIG. 7. In step 234, indexing engine 110 determines if the video frame having the matched clock time occurs at the beginning or end of a video sequence. In particular, segment lists generally provide the time that a sequence begins. In a football game, the clock times provided in a PBP will generally be the time a play begins. However, there are instances where the clock time provided is the time that a play ends. For example, the PBP for the last play in a drive (e.g., a fourth down punt) may typically list the ending time of a play.

There are a number of ways the indexing engine 110 may recognize whether the identified video frame is at the beginning or end of a sequence. In embodiments, the indexing engine may receive information (for example from the received segment list) as to the type of event that the segment list and video relate to. The indexing engine 110 may the apply heuristics which have been stored (locally or remotely) which have been developed and stored for that type of event.

As an example, in football, individual plays are generally characterized by the players being relatively still before a play begins, then frantically moving during the play, and then moving slowly at the completion of the play. Where the indexing engine 110 receives information that the type of event is a football game, the indexing engine can examine frames before and after the identified video frame to determine the type of movement that is occurring (amount of change from frame to frame). From this, the indexing engine 110 may make a determination as to whether the identified frame is at the start or end of a play.

As another example, it is known how long football plays generally take. If the time listed in the preceding segment on the segment list is too large for a typical play, that can indicate that the current time is from the end of the next subsequent play. Other football-specific and generalized heuristics can be employed for football games, and other event-specific and generalized heuristics can be applied to events other than football games.

Another example is to use shot and/or scene detection on the video to break it into shots. In this example, the indexing engine 110 can find a video frame containing the clock time (or some other identifiable signature), thereafter find the sequence that the clock time or signature is contained in and then use the start/end time of the found sequence.

If the indexing engine 110 determines in step 234 that the matched clock time is at the start of a segment, the indexing engine 110 may determine the end of the video sequence in step 238. It may do so using the same or similar heuristics applied in step 234. For example, in a football game, the video may be examined to find the start of the play and then thereafter when the players slow down and stop. This may be considered the end of the play. The determined start and end times of the video sequence determined to correspond to the current segment may be stored.

Conversely, if the indexing engine 110 determines in step 234 that the matched clock time is at the end of sequence, the indexing engine 110 may determine the start of the sequence in step 240. Again, the same or similar heuristics as applied in step 234 may be applied in step 240 to work backwards from the end the sequence to determine the start of sequence. The determined start and end times of the video determined to correspond to the current segment may be stored.

When a user views a video sequence as explained below, it may be desirable to have a buffer at the start and end of the video sequence to provide a lead in and lead out for the video sequence. As such, in step 244, the indexing engine 110 may add a buffer of for example a few seconds to start and end of determined length of the video sequence. The buffer at the start or end of a video sequence may be omitted in further embodiments.

Referring again to FIG. 6, once a specific video sequence (including the video of a sequence and a start and end buffer) has been indexed to a segment from the segment list, an index table may be created and stored in step 224. The index table may store the indexed video sequence in association with the corresponding segment from the segment list. The index table may store, for each segment from the segment list, the start and end times where the corresponding video is found in the stored video. In further embodiments, the indexing engine 110 may store the specific video sequences separately, one stored video sequence for each segment in the segment list.

In step 228, the indexing engine 110 may check if there are more segments in the segment list for matching to sequences in the video. If so, the indexing engine 110 return to step 216 to get the time of another segment from the segment list, and steps 220, 222, 224 and 228 are repeated. On the other hand, if all segments in the segment list 116 have been accounted for in step 228, the indexed video 160 is completed and stored in step 230. The video may be indexed by time-stamping the corresponding segments in the segment list to their corresponding video sequence in the video.

As noted above, not all video events have a running game clock. Certain athletic contests such as baseball and tennis matches may be played to completion regardless of how long they take. Additionally, the present technology may operate on stored video events unrelated to sports, and which have no running game clock. If no game clock is discerned from examining frames of a video in step 214, the indexing engine 110 may next look for a segment signature as shown in step 250 of FIG. 8.

A segment signature may be data describing a particular frame of video from the stored video of the event. This segment signature may be generated by the third-party at the time they prepare the segment list, and may describe a video frame at the start of a segment, though it may be the end of a segment in further embodiments.

As one example, a segment signature may be stored image data (jpeg, gif, etc.) from a single frame of the video which the third-party provider grabs from the video at the start of a video sequence and stores in association with the segment from the segment list. Thus, each segment from the segment list will have an associated segment signature which describes a single point in the video of the event. In further embodiments, the segment signature may be a time in the video. That is, the video of the event begins at time t₀, a first sequence starts at video run time t₁, a second sequence starts at video run time t₂, etc. The segment signature for a particular sequence may thus be the video run time at which that sequence begins (or ends).

In step 250, the indexing engine 110 may check whether the segments in the segment list received from a third party include associated segment signatures. If not, the indexing engine 110 may not generate the interactive script for that video and the operation of the indexing engine 110 may end.

On the other hand, if segment signatures are included with the segment list, in step 252 the indexing engine 110 may determine whether a given stored segment signature matches to a point in the video. As indicated above, this comparison may involve comparing stored image data against the image data of successive frames of the video until a match is found.

A number of technologies exist for abstracting or summarizing data of a signature and video frames for the purposes of comparison and finding a match. One example of such technology is disclosed in US Patent Publication No. 2012/0008821 entitled “Video Visual and Audio Query.” That patent publication describes different examples for extracting image signatures from video frames, to be compared with each other in order to find matching video frames. In one such example, the system divides each video frame image into 64 (8×8) equal size rectangular ordered cells. In each cell, the system can generate two ordered bits. For example:
a. 1st bit=1 if the right half of the cell is brighter than the left half, and =0 if it's darker.
b. 2nd bit=1 if the upper half of the cell is brighter than the lower half, and =0 if it's darker.
   Using this system, for both the signature and the video frames in a video, the indexing engine 110 can develop ordered lists of 128 bits each, coming from the 64 ordered cells in a signature/video frames. The ordered lists from the signature can be compared against the ordered list of the video frames to find a match. Other examples from Patent Publication No. 2012/0008821 may also be used.

Instead of image data from the video, it is conceivable that the signature be audio data, for comparison against audio data in the video. An example for comparing audio data from a signature and video is disclosed in US Patent Publication No. 2012/0296458, entitled “Background Audio Listening for Content Recognition.” One example disclosed in that patent publication, a signature comprised of sequence of audio can be processed using a feature extraction algorithm in any of a variety of ways including for example applying a Hamming window to the audio data, zero padding the audio data, transforming the data using fast or discrete Fourier transform, and applying a log power. This processed audio signature may then be compared against audio segments from the video, which may be processed in a similar manner.

Other known technologies for processing image and/or audio data from the video and four performing the comparison of the data may be used. As indicated above, the matching may instead involve finding the video run time corresponding to the video run time stored as the segment signature for a given segment.

If no match is found in step 252, the indexing engine may check for more segments in the list in step 228 (as above). On the other hand, if a match is found, the segment associated with the segment signature is indexed to the video including the matched video point. In particular, the indexing engine may determine a length of the video sequence to index to the matched segment from the segment list (step 222), and the length of the indexed video sequence may then be stored in association with the matched segment from the segment list (step 224), which steps have been explained above. In step 228, the indexing engine 110 may check if there are more segments in the segment list for matching to a point in the video. If so, the indexing engine 110 may return to step 252 to get the next segment signature from the segment list, and steps 252, 222, 224 and 228 are repeated. If there are no more segments in the segment list, the indexed video 160 is completed and stored in step 230 as explained above.

It may happen that a stored video, such as that for sporting event, may include video replays of certain sequences. For example, in a football game, networks often show replays of eventful passes, runs, defensive plays, penalties, etc. In embodiments, it may be advantageous to identify a video replay of the sequence as opposed to the video of the underlying sequence itself For example, when indexing segments from the segment list to video sequences, it may be beneficial to index to the video sequence itself instead of or in addition to a replay of the video sequence. It may also be beneficial to include a replay in the highlight reel in addition to the underlying video sequence.

Various generalized and event-specific heuristics may be employed by the indexing engine 110 to identify a replay of a sequence and distinguish that replay from the underlying sequence. For example, in football games, replays are generally shown without display of the running game clock. Additionally, networks typically flash a network logo or some other graphic at the start and end of a replay to highlight that it is a replay that is being shown. Replays are also often shown at slower than normal speeds. The indexing engine 110 may include rules to look for these and other characteristics of a replay so as to determine when the video is of a replay. Once a replay is identified, it can be omitted or included from a video highlight reel by the selection module 162 explained below.

It is possible that a segment in the segment list can be indexed to two different parts of the video. In the example of a football game, if a play is shown live, and then a replay is shown later in the broadcast, the play are replay may be covered by a single segment. However that segment may be indexed to two different sections of the video (the first being the underlying play and the second being the replay of the play).

Referring again to the schematic block diagram of FIG. 5, once the video is indexed, the HLR generation engine 112 can form a highlight reel from the indexed video. In further embodiments, it is conceivable that the highlight reel be formed first, and then that highlight reel indexed to the segment list in accordance with the flowcharts of FIGS. 6-8.

The operation of the HLR generation engine 112 to form a highlight reel includes two modules. As shown in FIG. 5, a first module, referred to as a selection module 162, selects video from the indexed video 160 for inclusion in the highlight reel. Further detail relating to the operation of the selection module 162 are provided below with respect to the flowchart of FIGS. 9A and 9B. A second module, referred to as an augmentation module 164, processes the selected highlight reel videos together with an introduction, transitions between highlight videos, and/or audio voice overs to form a finished highlight reel 166 having a professional look and feel. Further detail relating to the operation of the augmentation module 164 are provided below with respect to the flowchart of FIG. 10.

Referring now to the flowcharts of FIGS. 9A and 9B, the selection module 162 analyzes the segment list 116 along with other information, and selects highlight reel videos 172 from the indexed video 160 for inclusion in the highlight reel. It is understood that the selection module 162 may select video sequences for the highlight reel according to a wide variety of models and using a wide variety of criteria and rules.

FIG. 9A presents one example employing a probabilistic model to determine whether a given segment from segment list 116 appreciably changes a likely outcome of a given event. If so, it may be included in the highlight reel. The selection module 162 may retrieve user preferences 170 in step 300, and may retrieve statistical history 176 for the type of event covered by the segment list in step 302.

User preferences 170 may include a list, for example built up by a user over time, of the type of content that a user is interested in. In a sports context, user preferences may include for example a user's favorite sports, sports teams and players; channels and sporting events he/she would like to watch and sports content he/she would like to receive; fantasy teams, rosters and schedules, etc. This information may additionally or alternatively include a wide variety of other non-sports related information. User preferences 170 may be stored locally within memory 113 (FIG. 1) of the computing device 100, or remotely on a service for example including remote storage 122. As explained, user preferences play a role in which video sequences are selected into a highlight reel. Thus, the present system may generate different highlight reels of the same event for different users, depending on their stored user preferences.

The statistical history 176 may provide a probabilistic outcome for a wide variety of combinations of statistical data. For example, in a football game, the statistical data may indicate that, if the score is 17:14 in favor of the home team, there is 3 minutes left in the 3rd quarter, and the home team is on offense at the other team's 33 yard line with a 1st down and 10 yards to go, the probability is that the home team will win 55% of the time. Each of the preceding items of data, referred to herein as state data, is by way of example only, and varying one or more of these items of state data may change the probabilistic outcome according to the statistical history data. It is also understood that this type of statistical data may exist a wide variety of other events, enabling probabilistic outcomes for these events for a given set of statistical data. The statistical history for different events covering a plurality of years may be stored, either on remote storage 122 or locally within memory 113 of computing device 100.

In step 304, the selection module 162 may evaluate the state data for a given segment. In one example, the selection module start with the first segment in the segment list and proceed sequentially, though it may be otherwise in further embodiments. In step 306, the selection module 162 may determine the probabilistic outcome of the event described by the segment list using the state data for the segment then under consideration together with the statistical history for the type of event covered by the segment list.

In step 308, the selection module 162 may determine any change in the probabilistic outcome of the current segment relative to the probabilistic outcome of one or more previous segments. In step 310, the selection module 162 determines whether this change is greater than some predefined threshold. Step 308 and 310 (as well as other steps in FIG. 9A) are based on the understanding that a segment which appreciably (above some predefined threshold) changes the probabilistic outcome of the event is a noteworthy segment and should be included in the highlight reel. If the segment under consideration does not appreciably change the probabilistic outcome, the flow may skip to step 318 to see if there more segments to consider.

On the other hand, if the segment does appreciably change the outcome, the flow may next check in step 312 whether a user has set the length of the highlight reel 166. Where a user chooses a length, the selection module 162 may check in step 314 whether the segment under consideration (in particular, the video sequence associated with that segment) is too long for the defined length. The selection module 162 may make this determination in a number of ways. In one example, the selection module 162 has data relating to the average length of video sequences in the indexed video 160. This may vary depending on the type of event captured in the indexed video. Where the length of a video sequence is longer than the average, that video sequence may be omitted from the highlight reel 166 in step 314, especially where a user has set a particularly short overall length of the highlight reel. The selection module 162 may alternatively or additionally look at how much time remains in the user-specified length of the highlight reel, and the number of segments still to consider, and make a determination as to whether to add the current segment to the highlight reel.

In further embodiments, the selection module 162 may consider how significant a segment is (the degree to which it changes the probabilistic outcome of the event) in combination with how long it is when determining whether the associated video sequence is too long to include in the highlight reel. Thus, where a video sequence is particularly long, but also particularly significant, the selection module 162 may include it in the highlight reel, even where the user has set a short length of the highlight reel. Determination of the significance of a segment is described below.

If the segment appreciably change the outcome, and is not too long (or no length was set) the segment to be added to the highlight reel in step 316. In step 318, the selection module 162 checks for more segments. If more segments are found, the next segment is called in step 320, and the flow returns to step 304 to evaluate that segment as described above. Where there are no further segments in step 318, the selection module 162 stores the segments selected for the highlight reel in step 322, and generates and stores an interactive script in step 324. As explained below, the interactive script may be displayed on a user interface to allow browsing of the highlight reel videos.

FIG. 9B presents a further example of how the selection module 162 may choose video segments for inclusion in the highlight reel. In the embodiment of FIG. 9B, the selection module 162 retrieves user preferences 170 in a step 330, and chooses a segment from the segment list 116 for analysis in a step 334. The selection module 162 may cycle through segments sequentially, though it may analyze the segments in other orders in further embodiments.

A user may set the length of the highlight reel 166 in step 336. Where a user chooses a length, the selection module 162 may check in step 338 whether the segment under consideration (in particular, the video sequence associated with that segment) is too long for the defined length. The selection module may use the methods described above for making this determination or other methods.

Assuming a user has not set the length of the highlight reel in step 336, or a video sequence is not determined to be too long in step 338, the selection module 162 next looks to whether a segment correlates to a user preference in step 342. As one of many examples, a segment may name a particular player as being involved in the segment, and that same player may be stored as one of the user's favorites or on the user's fantasy team in the user preferences. As another example, a user may have a saved preference to see sequences involving particular results, such as for example quarterback sacks. Segments having state data relating to quarterback sacks may then be selected in step 342. As noted, the segment may relate to a wide variety of other topics which may be of particular interest to a user and stored in the user preferences, including a variety of sports and non-sports related features. This step may be performed by a keyword search of the segment and the user stored preferences to find matches. Where a match is found, the segment may be added to the highlight reel in step 352. Where no match is found, the flow may proceed to step 346.

Even where segment is unrelated to a user preference, the segment may be noteworthy or significant in and of itself. For example, in a football game, a play involving a long pass or run, a touchdown, interception, sack or fumble may be considered noteworthy independent of other factors. In baseball, segments involving various hits, a run scored or good fielding play may be considered noteworthy. In soccer, a goal, penalty kick or good defensive play may be considered noteworthy, etc. Where segment is determined to be noteworthy in step 346 by the selection module 162, the segment may be added to the highlight reel in step 352. Otherwise, the flow may proceed to step 350.

In step 346, the selection module 162 may employ a variety of different stored criteria or rules for determining a threshold noteworthiness for segment to be added to the highlight reel. In examples, these thresholds may be quantitative. For example, in a football game, net yardage gains of at least a predetermined number of yards may meet the quantitative threshold of being considered noteworthy. Plays longer than a predetermined length of time may relate to long runs or long scrambles, and thus many considered noteworthy. Plays resulting in touchdowns or field goals may also be considered to meet the threshold level of noteworthiness. Plays resulting in at least a predefined number of fantasy points for one or more of the user's fantasy players may be considered to meet the threshold level of noteworthiness. A wide variety of other criteria may be employed for determining a threshold noteworthiness for segments to be added to the highlight reel in step 346.

It may happen that a segment is not interesting in and of itself, but given the context in which the segment occurs that segment may be considered noteworthy and added to the highlight reel. For example, a short run or pass play in a football game may not be that interesting. However, given the context in which it occurs, such as to gain a first down at a critical time late in a close game, it may be noteworthy and worthwhile including in the highlight reel. In step 350, the selection module 162 determines whether a segment is contextually noteworthy. If so, the segment is added to the highlight reel in step 352.

As above, the selection module 162 may employ a variety of different criteria or rules for determining a threshold contextual noteworthiness for segment to be added to the highlight reel. For example in a football game, all plays resulting in a first down may be considered contextually noteworthy where they occur late in the game (e.g., last two minutes) and where the teams are tied or within a predetermined point differential of each other (e.g., 7 points). A wide variety of other rules may be employed for determining a threshold contextual noteworthiness for segments to be added to the highlight reel.

It is understood that other factors may be used in determining how and when to add segments to a highlight reel in step 352. For example, in a further embodiment, each of the segments may be scored, using a combination of the above-described factors. In such an embodiment, user preferences, the significance of a segment, and the context in which the segment occurred may each be considered and each factor may be quantified using predefined scoring rules to result in a net score for each factor. The score for each factor may be summed, and segments above some threshold may result in a noteworthy segment. The predefined scoring rules may use any of the above-described criteria, such as for example, net yardage in a play, length of the play, whether the play resulted in game or fantasy player points. Other factors such as whether there was a turnover on the play, penalty or whether there was a replay shown of the play may also factor into the score.

In embodiments described above, the segment list 116 is used to determine whether a segment should be added to the highlight reel. In further embodiments, the indexed video 160 may additionally be used. For example, the indexed video 160 may include an audio soundtrack. It may be assumed that crowd noise increases for interesting plays in a game. Thus, where crowd noise rises above a predefined decibel level for a predefined period of time, the video sequence occurring at that time may also be added to the highlight reel (or receive a high score for this particular factor).

If a segment is not contextually noteworthy in step 350, or where a segment has been added to the highlight reel of step 352, the flow proceeds to step 354 to determine whether there are additional segments to analyze for possible addition to the highlight reel. If there are more segments, the flow returns to step 334, and the above-described steps are repeated. If there are no further segments, the selection module 162 stores the video sequences selected into the highlight reel in step 356, and generates and stores an interactive script in step 360.

As explained below, the interactive script may be displayed to a user on the user interface 134. The user may select script segments from the interactive script, and then be shown the video sequence from the highlight reel which has been indexed to that script segment. Each script segment from the interactive script may be generated from the respective segments from the segment list. For example, a script segment may be populated with some or all of the data fields and/or parsed text from a segment in the segment list. Thus, the video sequences can be said to be indexed to the script segments, in that the video sequences are indexed to segments from the segment list, which segments are in turn used to generate corresponding script segments in the interactive script.

Additionally, each script segment may include hypertext or otherwise be hyperlinked to the index table created and stored in step 224. Thus, when a user selects a particular script segment from the interactive script, the index table may be accessed to determine which indexed video sequence is associated with that script segment. Instead of being created by the indexing engine 110, some or all of the interactive script may be generated by browsing engine 134 as explained below.

In embodiments, the video segments selected into the highlight reel come from coverage of a single event, such as a single football game, baseball game, talk show, etc. However, in further embodiments, the video segments selected into the highlight reel may come from coverage of multiple events. The events may or may not be related to each other. In such an embodiment, multiple videos and segments list may be used in forming the video highlight reel.

Referring again to FIG. 5, once videos 172 have been selected for the highlight reel by the selection module 162, the highlight reel videos 172 may be processed, or augmented, into the finished highlight reel 166 by the augmentation module 164. In addition to the highlight reel videos 172, the augmentation module 164 generates and adds an opening video clip 180, transitional video clips 182, a closing video clip 184 and/or an audio overlay generated in part from an audio overlay store 174. When processed together by the augmentation module 164, these features provide the highlight reel 166 with a look and feel of a highly polished, manually produced professional television broadcast, for example including voice overlays, and introductory and transitional screenshots.

Further details of the operation of the augmentation module 164 will now be explained with reference to the flowchart of FIG. 10. In step 364, the augmentation module 164 may generate an opening video clip 180 to start and introduce the highlight reel 166. The opening video clip 180 may be similar to the opening of a quality highlight TV broadcast, and may instill in the user a feeling that the user is viewing a professionally choreographed television show. However, unlike a TV broadcast which is put together by a team of individuals, the highlight reel 166 according to the present technology may be automatically created.

The opening video clip 180 may render broadcast-style graphics that includes for example a highlight reel title and video previews, possibly with titling graphics, of the upcoming clips. The opening video clip may include an audio track of music or talk as well. This audio may be taken from the videos 172 in the highlight reel 166, or from audio overlay store 174 as explained below.

The augmentation module 164 may employ one or more software templates using a markup language to set the overall layout, appearance and animation flow of the opening video clip. The markup language templates can dynamically change, or swap, assets to customize the opening video clip for a given highlight reel. Swappable assets may come from a stored stock of assets and/or from metadata associated with videos in the highlight reel or the segment list 116. The augmentation module 164 can choose which assets to include in the markup language template based on the content of the highlight reel videos and from the metadata associated with the video and segment list.

Some of the elements that may be swappable include background, midground, title field, portraits and other types of graphics. In embodiments, the augmentation module 164 examines the selected highlight reel videos and associated metadata and makes a determination as to which assets to include in the template. At a rendering step of the highlight reel (or before), the template displays the opening video clip with the selected assets. The markup language templates for the transitional video clips and closing video clips, described below, may function in a similar manner.

The one or more markup language templates of the augmentation module 164 for the opening video clip 180 may be populated with textual graphics, such as for example a user's name and other profile information. Other textual graphics such as for example a general subject matter of the selected highlight reel videos may be included. For example, if all of the clips have a common overarching theme (a user's fantasy team, favorite team or player, current events, etc.), a title for the playlist may be included in the metadata for the selected highlight reel videos 172 or segment list 116 and used by the markup language template(s) for the opening sequence. Other textual graphics such as the date, length of playlist, source of the playlist, etc. may be included.

The markup language template(s) may further receive the opening or highlight frames from the metadata of one some or all of the video clips for display in the opening video clip as a preview of what is to come in the highlight reel. These may play in succession (0.5 to 1.5 seconds each, though the length of time the frames are shown may be shorter or longer than this in further embodiments). These frames may play after the textual graphics, or together with the textual graphics, for example below the textual graphics, off to the side of the textual graphics or as a background behind the textual graphics. Instead of playing in succession, the frames may be displayed all at once, for example as thumbnails below the textual graphics, off to the side of the textual graphics or as a background behind the textual graphics.

After creation of the opening video clip, the augmentation module 164 may create transitional video clips 182 in step 368 introducing the first (and then subsequent) video clips in the highlight reel. The markup language template for the transitional video clip may be populated with textual graphics, such as for example a title of the upcoming video clip received from the metadata from the upcoming video clip or associated segment from the segment list 116. Other textual graphics such as the date, countdown clock to the start of the video clip, length of the video clip, countdown clock showing the time to the next video clip, source of the video clip, etc. may be included. Other non-textual graphics may be included, such as for example team logos and/or logos from remote storage 122.

The markup language template(s) for the transitional video clips 182 may further receive the opening or highlight frames from the metadata of the upcoming video clip/segment list as a preview of what is to come in the video clip. These one or more frames may play after the textual graphics, or together with the textual graphics, for example below the textual graphics, off to the side of the textual graphics or as a background behind the textual graphics.

The content included in the transitional video clips 182 may vary depending on the associated highlight reel video sequence. For example, if the upcoming video clip focuses on a player, the transitional video clip may provide statistics and other information for the player.

In step 370, the augmentation module 164 may further generate a closing video clip 184. The closing video clip 184 may be similar to the closing of a traditional broadcast television show, and may instill in the user a feeling of the user viewing a professionally choreographed television show. The closing video sequence may render broadcast-style graphics that includes any of the textual graphics and/or frames described above. It may include a further closing salutation textual graphic indicating the highlight reel is over, such as for example displaying “End,” or “Your Highlight Reel Entitled [title of highlight reel from metadata] Has Completed.” Other closing text may be used in further embodiments.

The closing video clip 184 may be created by one or more markup language templates of the augmentation module 164. The software templates receive assets from the metadata associated with one, some or all of the video sequences/segment list to create the closing video sequence.

In addition to opening, closing and transitional clips, the selected highlight reel videos 172 may be augmented themselves by adding an audio track over the videos 172 in step 372. The augmentation module 164 may work with one or more software templates as described above which have access to a number of canned audio phrases, which vary depending on the underlying context of the highlight reel. For example, there would be a separate library of canned audio for football highlight reels, baseball highlight reels, basketball highlight reels, etc. There could be separate libraries of canned audio for a variety of other non-sports related highlight reels as well.

The markup language templates fuse together contextual audio data from segment list with these audio phrases to provide a contextually relevant voice overlay for a given portion of one or more of the highlight reel videos. The templates can dynamically change, or swap, audio data assets to customize the voice overlay for a given video segment of the highlight reel. Swappable audio assets may come from a stored stock of assets and/or from audio metadata associated with videos in the highlight reel or the segment list 116. The augmentation module 164 can choose which assets to include in the markup language template based on the content of the highlight reel videos and from the metadata associated with the video and segment list. Where a voice layover is provided by the augmentation module 164, the audio recorded with the video sequence can be muted during the voice overlay, and then return upon completion of the voice overlay.

After the selected highlight reel videos 172 have been augmented with an opening clip, transitional clips, closing clip and/or audio overlays, the finished highlight reel 166 may be rendered in step 376. Thereafter, the highlight reel 166 is stored and made available for viewing. The highlight reel may alternatively be rendered at the time it is displayed. As mentioned above, the addition of these features provides a highlight reel with a professionally choreographed look and feel. However, it is understood that one or more of the above described opening clip, transitional clips, closing clip and voice overlays may be omitted in further embodiments. It is conceivable that the augmentation module 164 may be omitted altogether, at which point the selected highlight reel videos 172 are used as is as the finished highlight reel 166.

The augmentation engine 164 has been described as adding features that play in the finished highlight reel together with videos 172 selected into the highlight reel. However, in further embodiments, the videos 172 selected for the highlight reel may themselves be altered and/or augmented. For example, in a sporting event highlight reel, the ball or puck or other object within the video may be highlighted. It is also possible to highlight key-frames in the video with a “flash+hold” effect. The key-frame is highlighted to simulate a camera flash. The key-frame is then repeated for around a second in the video. This provides a compelling graphics effect to the highlight video 172.

Referring again to the schematic diagram of FIG. 5, once the highlight reel is generated, it may be stored as a video file in a variety of video formats. In further embodiments, the highlight reel may be generated “on the fly.” That is, a video is indexed, highlight video sequences are selected, possibly augmented, and then rendered directly to a display (or downloaded streamed).

When a highlight reel is displayed, it may be displayed straight through as a linear video without the user interacting with the video. However, in embodiments, the present technology may further provide a user interface 134 including an interactive script 150 that allows a user to interactively browse the highlight reel. Using the interactive script 150, a user may instantly jump forward or backward to a desired highlight reel video 172 in the highlight reel 166.

The user interface 134 and interactive script 150 may be implemented by the browsing engine 124. Operation of an embodiment of the browsing engine will now be explained with reference to the flowchart of FIG. 11, and the illustrations of FIGS. 3-4 and 12-14.

In step 260, a user may access an interactive script for a stored highlight reel 166 for display on a user interface 134. The interactive script includes a listing, or script, of the segments in the highlight reel 166, set up with hypertext or with hyperlinks. The links are set up so that, once a specific script segment is selected, the indexing table retrieves and displays the associated highlight reel video sequence from memory.

The user interface 134 may be displayed on a display of the computing device 120 as shown in FIG. 3, or the user interface 134 may be displayed on a display 138 associated with the computing device 130 as shown in FIG. 4.

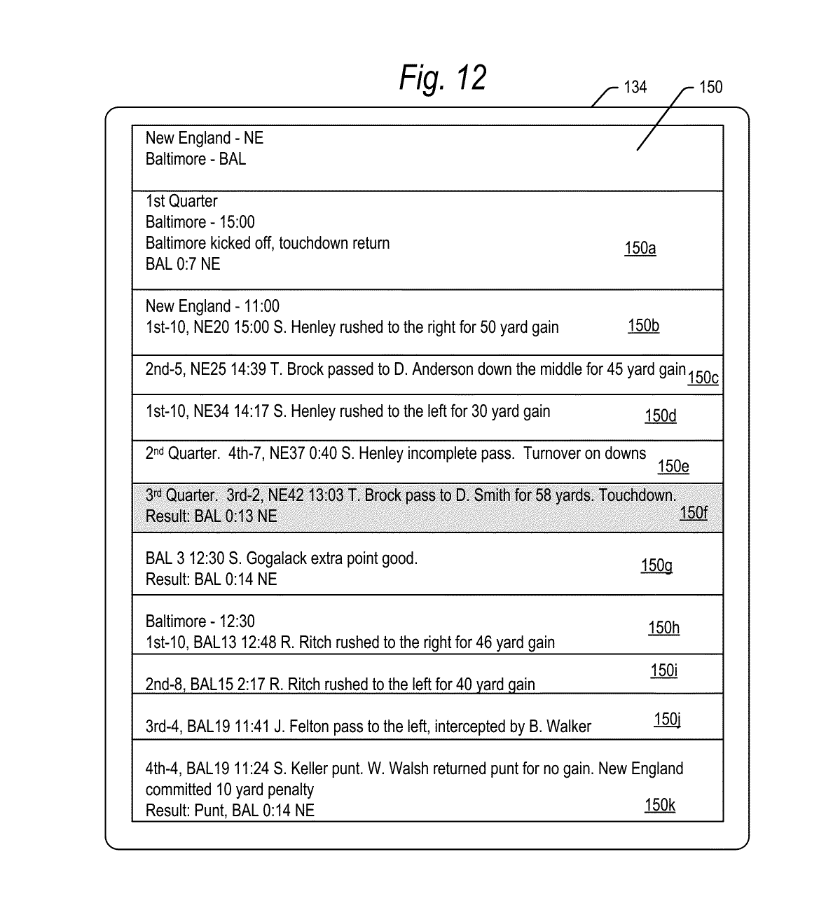

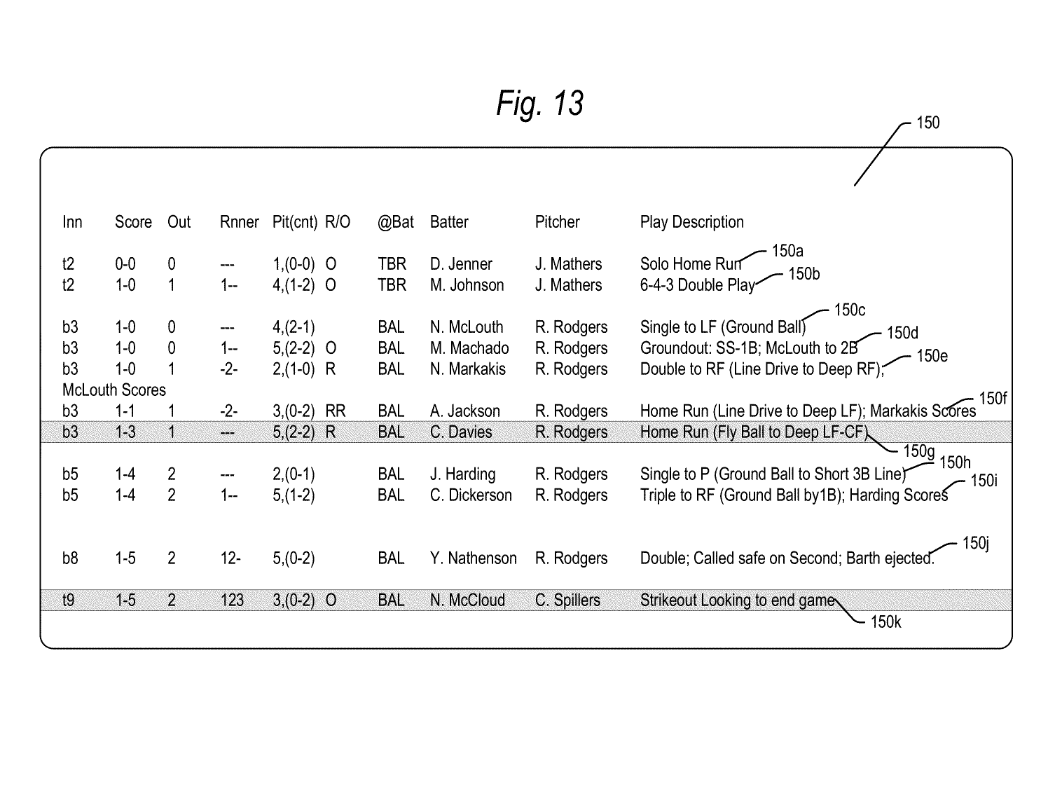

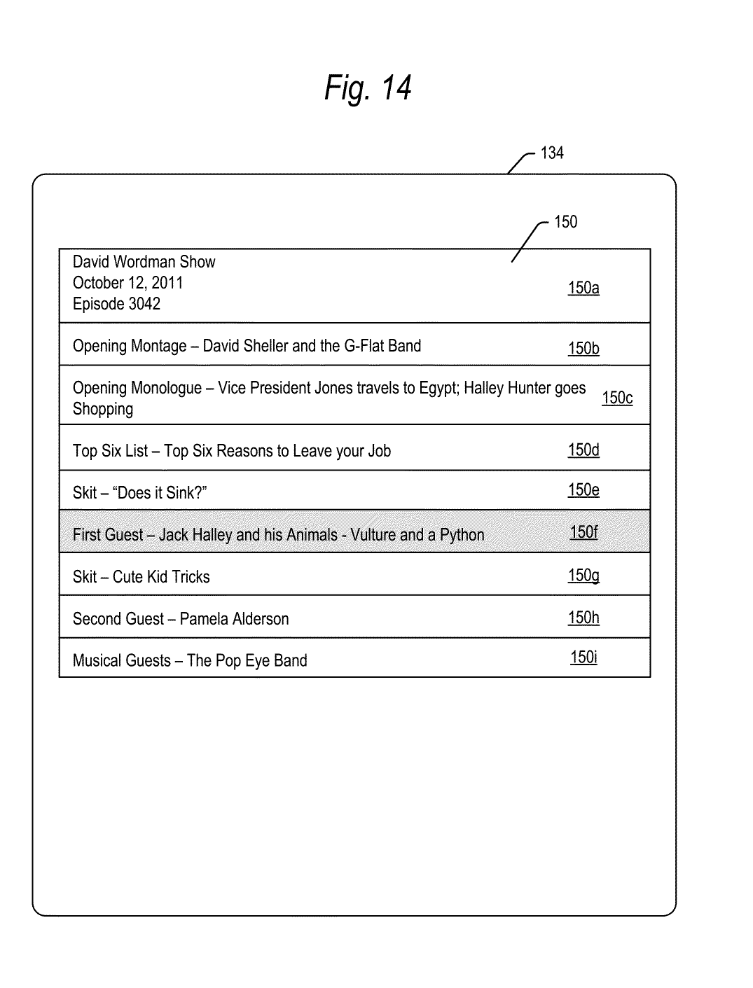

FIGS. 12-14 illustrate examples of different interactive scripts 150 which may be displayed for highlight reels 166 by the browsing engine 124 on user interface 134. FIG. 12 is an interactive script 150 associated with a stored highlight reel of a football game. FIG. 13 is an interactive script 150 associated with a stored highlight reel of a baseball game. FIG. 14 is an interactive script of a stored highlight reel of a non-sports related event, a talk show in this example.

The interactive scripts of FIGS. 12-14 are by way of example only, and may vary widely in different embodiments. However, in general, the interactive script 150 allows a user to select a particular script segment displayed on the interactive script 150, and the indexed highlight reel video sequence is in turn displayed to the user from the stored highlight reel video. The interactive script 150 may be stored locally on computing device 120 and/or 130. Alternatively, the interactive script 150 may be stored in remote storage 122 (FIG. 2) and downloaded to computing device 120 and/or 130. As noted above, the indexed video associated with the interactive script 150 may be stored locally on computing devices 120 and/or 130, or remotely in storage 122.

As seen in FIGS. 12-14, an interactive script 150 may include script segments 150a, 150b, 150c, etc., each being selectable with hypertext or a hyperlink. The interactive script may include the same or similar descriptive elements as the underlying segment list, such as a description of the indexed video sequence and, if applicable, players involved in the sequence and a game clock time showing the start or end time of the indexed video sequence. In appearance, the displayed interactive script may be similar to or the same as the underlying segment list used to generate the interactive script. In embodiments, the interactive script may in fact be the segment list, augmented with hypertext or hyperlinks that enable retrieval of the appropriate highlight reel video sequence upon selection of a particular script segment. The interactive script 150 need not have the same or similar appearance as the underlying segment list in further embodiments. The interactive script 150 may include fewer or greater numbers of highlight reel script segments than are shown in the figures.

In step 262, the browsing engine 124 may look for user selection of a script segment from the interactive script 150. Once a selection is received, the browsing engine 124 finds the highlight reel video sequence indexed to the selected script segment in step 264 using the stored index table. That video sequence is then displayed to the user in step 266, for example on display 138. It is conceivable that a user may be able to select multiple script segments. In this instance, the multiple video sequences indexed to the multiple selected script segments may be accessed, and then played successively. Upon completion of a displayed video sequence, the closing video clip may be displayed and/or the video may end. Alternatively, the stored video may continue to play forward from that point.

As an example, referring to FIG. 12, a user may select script segment 150f relating to a 58 yard touchdown pass from T. Brock to D. Smith. A user may select script segment 150f via a pointing device such as a mouse, or by touching the user interface where user interface is a touch sensitive display. In embodiments utilizing a NUI system as shown in FIG. 4, a user may point to script segment 150f, verbally select the script segment 150f, or perform some other gesture to select the script segment 150f. Once selected, a video of the 58 yard touchdown pass may be displayed to the user from the video stored of the event.

Similarly, in the example of FIG. 13, a user may select script segment 150g of the home run by C. Davies and the segment 150k of the strikeout by N. McCloud. These video sequence may then be displayed to the user one after the other. In the talk show example of FIG. 14, a user may select one of the script segments from the show, such as for example script segment 150f, and the video sequence corresponding to that script segment may then displayed to the user. As noted above, the interactive scripts 150 shown in FIGS. 12-14, and the specific selected script segments, are by way of example only and may vary greatly in further embodiments.

Referring again to FIG. 11, instead of selecting a script segment, the browsing engine 124 and the user interface 134 may present the user with the ability to perform a segment search using a search query. For example, the user may be presented with a text box in which to enter a search query, at which point the browsing engine 124 searches the interactive script 150 in step 272 for all script segments that satisfy the search query. The search may be a simple keyword search, or may employ more complex searching techniques for example using Boolean operands.

In step 274, the browsing engine 124 determines whether any highlight reel script segments satisfy the search query. If not, a message may be displayed to the user that no script segments were found satisfying the search. On the other hand, if script segments were found satisfying the search query, those script segments may be displayed to the user, or otherwise highlighted in the overall interactive script 150. Thereafter, the flow returns to step 262 where the browsing engine 124 looks selection of a script segment.

Thus, in the football game example of FIG. 12, a user may choose to view all plays resulting in a “touchdown.” Upon entering the query “touchdown” in the text box, the browsing engine 124 can search through the interactive script 150 for all plays that resulted in a touchdown. As a further example, a user may follow certain players, for example their favorite players or players on their fantasy football team. A user can enter their name in the search query, and the browsing engine 124 can return all plays involving that player. The search query operations of browsing engine 124 can similarly operate in other embodiments, including for example the baseball game of FIG. 13 and the talk show of FIG. 14.

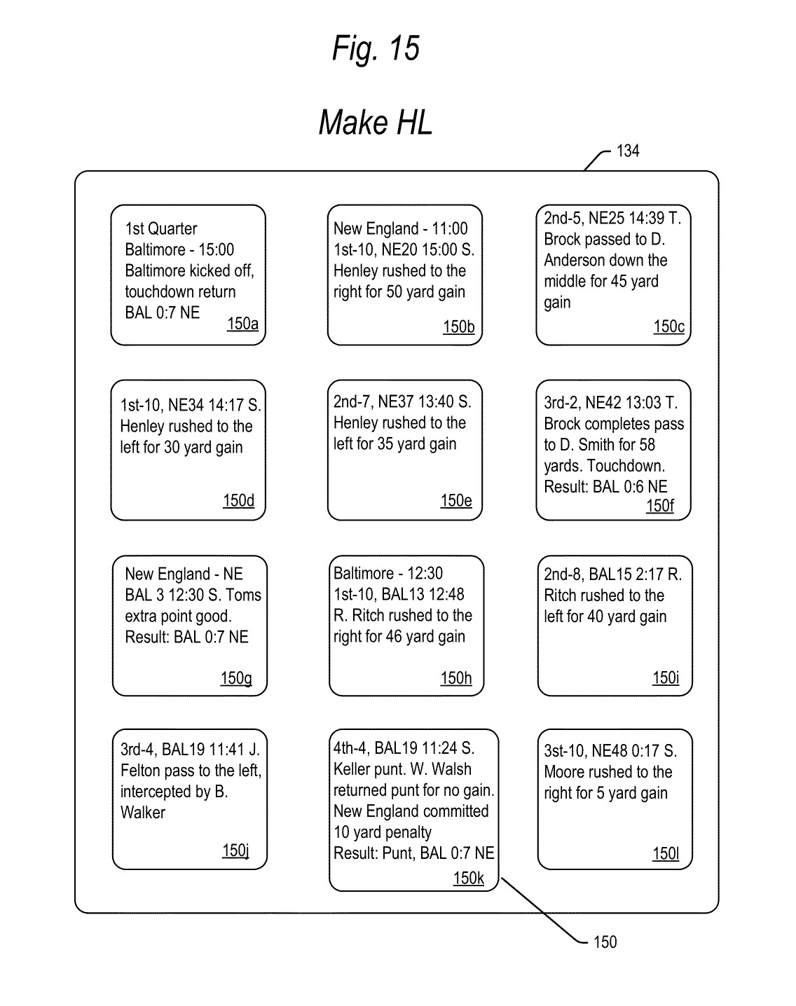

As noted, the appearance of the interactive scripts 150 shown in FIGS. 12-14 is by way of example only. FIG. 15 illustrates another possible appearance of the interactive script 150 where the individual script segments 150a, 150b, etc., are displayed as separate, selectable blocks. In a further example, the user interface 134 may display the interactive script 150 graphically. For example, for a football game, the browsing engine 124 can display a “drive chart,” graphically showing each play as an arrow displayed over a football field, with each arrow representing if and by how much the football was advanced in a given play. For basketball, the browsing engine 124 can display an image of the court with graphical indications showing from where shots were taken (the color of the graphical indication possibly representing whether the shot was made or missed). For baseball, the browsing engine 124 can display an image of the field with lines shown for where the ball travelled. Alternatively or additionally, an image of the strike zone can be displayed. In any of these examples, the browsing engine 124 can detect when a user has selected a particular segment from the graphical interactive script, and thereafter display the video sequence for that segment. Still further appearances of script segments from an interactive script 150 are contemplated.

In embodiments described above, the indexing engine 110, the highlight reel generation engine 112 and browsing engine 124 operate separately. However, in further embodiments, two or more of these software engines 110, 112 and 124 may be integrated together. In such an embodiment, the segment list may be used as the interactive script. That is, the segment list may be received from the third-party with hyperlinks, or otherwise augmented with hyperlinks, so that each segment in the segment list may be displayed on the user interface 134 as a selectable link.

In this embodiment, a user may select one of the segments displayed on the user interface 134. At that point, the combined indexing/browsing engine may examine the selected segment for a running clock time or a segment signature as described above. If found, the indexing/browsing engine may then examine the stored video to find the corresponding video sequence. That video sequence may then be displayed to the user, possibly adding a buffer at the start and/or end of the video segment.

A system as described above provides several advantages for a user viewing a stored event. First, the present technology can generate a highlight reel automatically and which is customized for a user. The highlight reel may include a variety of overlays to give it the look and feel of a high quality, manually produced television broadcast. Another benefit of the present technology is that a user may quickly and easily browse directly to points in the generated highlight reel that are of particular interest to the user, and the user can skip over other less interesting portions of the stored highlight reel.

FIGS. 16 and 17 illustrate examples of a suitable computing system environment which may be used in the foregoing technology as any of the processing devices described herein, such as computing devices 100, 120 and/or 130 of FIGS. 1-4. Multiple computing systems may be used as servers to implement the place service.

With reference to FIG. 16, an exemplary system for implementing the invention includes a general purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. Computer readable media can be any available tangible media that can be accessed by computer 710, including computer storage media. Computer readable media does not include transitory, modulated or other transmitted data signals that are not contained in a tangible media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the information and which can accessed by computer 710.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 16 illustrates operating system 734, application programs 735, other program modules 736, and program data 737.

The computer 710 may also include other removable/non-removable, volatile/nonvolatile computer storage media. By way of example only, FIG. 16 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 16, provide storage of computer readable instructions, data structures, program modules and other data for the computer 710. In FIG. 16, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 710 through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 795.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although a memory storage device 781 has been illustrated in FIG. 16. The logical connections depicted in FIG. 16 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 16 illustrates remote application programs 785 as residing on memory device 781. It will be appreciated that the network connections shown are exemplary and other means of establishing a communications link between the computers may be used.

FIG. 17 is a block diagram of another embodiment of a computing system that can be used to implement computing devices such as computing device 130. In this embodiment, the computing system is a multimedia console 800, such as a gaming console. As shown in FIG. 17, the multimedia console 800 has a central processing unit (CPU) 801, and a memory controller 802 that facilitates processor access to various types of memory, including a flash Read Only Memory (ROM) 803, a Random Access Memory (RAM) 806, a hard disk drive 808, and portable media drive 805. In one implementation, CPU 801 includes a level 1 cache 810 and a level 2 cache 812, to temporarily store data and hence reduce the number of memory access cycles made to the hard drive 808, thereby improving processing speed and throughput.

CPU 801, memory controller 802, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 801, memory controller 802, ROM 803, and RAM 806 are integrated onto a common module 814. In this implementation, ROM 803 is configured as a flash ROM that is connected to memory controller 802 via a PCI bus and a ROM bus (neither of which are shown). RAM 806 is configured as multiple Double Data Rate Synchronous Dynamic RAM (DDR SDRAM) modules that are independently controlled by memory controller 802 via separate buses (not shown). Hard disk drive 808 and portable media drive 805 are shown connected to the memory controller 802 via the PCI bus and an AT Attachment (ATA) bus 816. However, in other implementations, dedicated data bus structures of different types can also be applied in the alternative.

A graphics processing unit 820 and a video encoder 822 form a video processing pipeline for high speed and high resolution (e.g., High Definition) graphics processing. Data are carried from graphics processing unit (GPU) 820 to video encoder 822 via a digital video bus (not shown). Lightweight messages generated by the system applications (e.g., pop ups) are displayed by using a GPU 820 interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

An audio processing unit 824 and an audio codec (coder/decoder) 826 form a corresponding audio processing pipeline for multi-channel audio processing of various digital audio formats. Audio data are carried between audio processing unit 824 and audio codec 826 via a communication link (not shown). The video and audio processing pipelines output data to an A/V (audio/video) port 828 for transmission to a television or other display. In the illustrated implementation, video and audio processing components 820-828 are mounted on module 814.

FIG. 17 shows module 814 including a USB host controller 830 and a network interface 832. USB host controller 830 is shown in communication with CPU 801 and memory controller 802 via a bus (e.g., PCI bus) and serves as host for peripheral controllers 804(1)-804(4). Network interface 832 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 17, console 800 includes a controller support subassembly 841 for supporting four controllers 804(1)-804(4). The controller support subassembly 841 includes any hardware and software components to support wired and wireless operation with an external control device, such as for example, a media and game controller. A front panel I/O subassembly 842 supports the multiple functionalities of power button 811, the eject button 813, as well as any LEDs (light emitting diodes) or other indicators exposed on the outer surface of console 802. Subassemblies 841 and 842 are in communication with module 814 via one or more cable assemblies 844. In other implementations, console 800 can include additional controller subassemblies. The illustrated implementation also shows an optical I/O interface 835 that is configured to send and receive signals that can be communicated to module 814.

MUs 840(1) and 840(2) are illustrated as being connectable to MU ports “A” 830(1) and “B” 830(2) respectively. Additional MUs (e.g., MUs 840(3)-840(6)) are illustrated as being connectable to controllers 804(1) and 804(3), i.e., two MUs for each controller. Controllers 804(2) and 804(4) can also be configured to receive MUs (not shown). Each MU 840 offers additional storage on which games, game parameters, and other data may be stored. In some implementations, the other data can include any of a digital game component, an executable gaming application, an instruction set for expanding a gaming application, and a media file. When inserted into console 800 or a controller, MU 840 can be accessed by memory controller 802. A system power supply module 850 provides power to the components of multimedia console 800. A fan 852 cools the circuitry within console 800. A microcontroller unit 854 is also provided.

An application 860 comprising machine instructions is stored on hard disk drive 808. When console 800 is powered on, various portions of application 860 are loaded into RAM 806, and/or caches 810 and 812, for execution on CPU 801, wherein application 860 is one such example. Various applications can be stored on hard disk drive 808 for execution on CPU 801.

Multimedia console 800 may be operated as a standalone system by simply connecting the system to audio/visual device 16, a television, a video projector, or other display device. In this standalone mode, multimedia console 800 enables one or more players to play games, or enjoy digital media, e.g., by watching movies, or listening to music. However, with the integration of broadband connectivity made available through network interface 832, multimedia console 800 may further be operated as a participant in a larger network gaming community.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of generating a video highlight reel, comprising:
(a) indexing a video to a segment list setting forth the video sequences in the video to identify positions of different video sequences within the video; and
(b) adding one or more segments from the segment list to the highlight reel based at least in part on data contained in the one or more segments.

2. The method of claim 1, further comprising the steps of augmenting the one or more video sequences selected into the highlight reel by adding at least one of an opening video clip to the highlight reel, transitional video clips between video segments in the highlight reel, a closing video clip after a last video sequence in the highlight reel and an audio overlay to the one or more video sequences in the highlight reel.

3. The method of claim 1, wherein said step (a) of indexing a video to a segment list comprises the step of recognizing a feature within the video and correlating the recognized feature to data within the segment list.

4. The method of claim 3, wherein said step of recognizing a feature within the video comprises the step of recognizing a time displayed in the video and comparing that to times set forth in segments of the segment list to find a match to the recognized time.

5. The method of claim 1, wherein said step (a) of indexing a video to a segment list comprises the step of matching a segment signature to an image in the video.

6. The method of claim 1, wherein said step (b) of adding one or more segments from the segment list to the highlight reel based at least in part on data contained in the one or more segments comprises the step of determining a probabilistic outcome of an event based on data in a segment and adding the segment to the highlight reel where probabilistic outcome differs by a predefined amount from one or more probabilistic outcomes for one or more other segments.

7. The method of claim 1, wherein said step (b) of adding one or more segments from the segment list to the highlight reel based at least in part on data contained in the one or more segments comprises the step of comparing data from the segments in the segment list against stored user preferences to identify a correlation between segment data and at least a portion of the stored user preferences.

8. The method of claim 1, wherein said step (b) of adding one or more segments from the segment list to the highlight reel based at least in part on data contained in the one or more segments comprises the step of comparing data from the segments in the segment list against predefined rules defining threshold quantitative aspects to determine whether the data meets the threshold quantitative aspects.

9. The method of claim 8, wherein the video and segment list relate to a football game and wherein the quantitative aspects relate at least to how much time is left in a half and a point differential between teams in the football game.

10. A computer-readable medium for programming a processor to perform a method of generating an interactive video highlight reel, comprising:
(a) correlating segments in a segment list to video sequences in a video;
(b) identifying a video sequence for inclusion in the video highlight reel based at least in part on a significance of a segment, corresponding to the video sequence, to an outcome of an event covered by the segment list;
(c) displaying an interactive script including a plurality of script segments, a script segment of the plurality of script segments matched to the video sequence identified for inclusion in the video highlight reel in said step (b);
(d) receiving selection of the script segment displayed in said step (c); and
(e) displaying the video sequence matched to the script segment upon selection of the script segment in said step (d).

11. The computer-readable medium recited in claim 10, wherein said step (b) comprises the step of including a video sequence in the video highlight reel where a segment, correlated to the video sequence, includes data relating to a user preference for a user for whom the highlight reel is generated.

12. The computer-readable medium recited in claim 10, wherein said step (b) comprises the step of including a video sequence in the video highlight reel where a segment, correlated to the video sequence, includes data relating to a quantifiable threshold for inclusion in the highlight real.

13. The computer-readable medium recited in claim 10, wherein said step (b) comprises the step of including a video sequence in the video highlight reel where a segment, correlated to the video sequence, includes data indicative of a probable outcome that differs by a predefined amount from one or more probable outcomes indicated by one or more other segments.

14. The computer-readable medium recited in claim 10, further comprising the step of augmenting the highlight reel with at least one of an opening video clip, one or more transitional clips, a closing video clip and a voice overlay, the at least one of an opening video clip, one or more transitional clips, a closing video clip and a voice overlay including contextual information received from metadata associated with the segments of the video sequences of the highlight reel.

15. The computer-readable medium recited in claim 10, wherein said step (a) of correlating segments in a segment list to video sequences in a video comprises the steps of:
(f) identifying sequential alphanumeric text in segments of the segment list and sequences from the video; and
(g) indexing a segment of the segment list to a sequence of the video having the same alphanumeric text identified in said step (f).

16. The computer readable medium recited in claim 10, wherein said step (a) of correlating segments in a segment list to video sequences in a video comprises the steps of:
(h) identifying a game clock time in the video sequences;
(i) identifying a game clock time in the information contained in the segments of the segment list; and
(j) indexing a segment of the segment list to a sequence from the video having the same game clock time identified in said steps (g) and (h).

17. A system for generating a video highlight reel, comprising:
a video including a plurality of videos sequences from one or more events, a group of one or more video sequences selected for inclusion in a highlight reel;
one or more segment lists including a listing of segments corresponding to the video sequences from the one or more events;
an interactive script including script segments, displayed on a display of a computing device, the interactive script generated based on the segments of the segment list corresponding to the video sequences selected into the highlight reel, selection of a script segment from the interactive script displaying a corresponding highlight reel video sequence.

18. The system of claim 17, wherein selection of a script segment displays the corresponding highlight reel video sequence on the same display as displays the interactive script, the computing system implementing a natural user interface to interact with the interactive script.

19. The system of claim 17, wherein the display and computing device comprise a first display and a first computing device, selection of a script segment displays the corresponding highlight reel video sequence on a second display associated with a second computing device, the first and second computing devices having a communication link enabling communication between the first and second computing devices.

20. The system of claim 17, wherein the video and one or more segment lists relate to a sporting event.
